(19) United States
(12) Patent Application Publication
(10) Pub. No.: US 2007/0200501 A1
(43) Pub. Date: Aug. 30, 2007

(54) Plasma display panel (PDP)

(76) Inventor: Kunio Takayama, Suwon-si (KR)

Correspondence Address: Robert E. Bushnell, Suite 300, 1522 K Street, N. W., Washington, DC, 20005-1202, US

(21) Appl. No.: 11/709,757

(22) Filed: Feb. 23, 2007

(30) Foreign Application Priority Data
Feb. 27, 2006 (KR) 10-2006-0018870

(51) Int. Cl. H01J 17/49

(52) U.S. Cl. 313/582

(57) ABSTRACT

A Plasma Display Panel (PDP) has a reduced power consumption by forming transparent electrodes of the PDP so that the brightness of the PDP can be gradually reduced from a central region towards outer regions of the PDP. The PDP includes: a first substrate and a second substrate facing each other; a plurality of barrier ribs arranged between the first and second substrates to define a plurality of discharge cells; a plurality of sustain electrode pairs each having: a common electrode including a first bus electrode extending across the first substrate and a first transparent electrode bonded to the first bus electrode, each of the plurality of sustain electrode pairs is separated corresponding to each of the discharge cells, and has different areas in each discharge cell; and a scanning electrode including a second bus electrode extending across the first substrate and separated from the first bus electrode and a second transparent electrode bonded to the second bus electrode, the scanning electrode is separated corresponding to each of the discharge cells, and has different areas in each discharge cell; the areas of the first and second transparent electrodes are gradually reduced outwards from the center of the PDP; a first dielectric layer covering the sustain electrode pairs; a plurality of phosphor layers arranged within the discharge cells; and a discharge gas contained within each of the discharge cells.

### CLAIMS OF PRIORITY

This application makes reference to, incorporates the same herein, and claims all benefits accruing under 35 U.S.C. § 119 from an application earlier filed in the Korean Intellectual Property Office on the 27 Feb. 2006 and there duly assigned Serial No. 10-2006-0018870.

### BACKGROUND OF THE INVENTION

1. Field of the Invention

The present invention relates to a Plasma Display Panel (PDP), and more particularly, the present invention relates to a PDP having low power consumption.

2. Description of the Related Art

PDPs, which have recently drawn attention as a replacement for conventional Cathode Ray Tube (CRT) displays, are apparatuses that display images using visible light emitted though a process of exciting a phosphor material formed in a predetermined pattern with ultraviolet rays generated by a discharge of a discharge gas contained between two substrates on which a plurality of electrodes are formed.

Power consumption of recent PDPs have been reduced due to the increase in the luminous efficiency. However, such an increase is not sufficient. The power consumption of the PDP can be reduced if the brightness of the PDP is reduced. However, users do not want a PDP having low brightness. Therefore, it is desirable such that users cannot recognize the reduction of brightness with bare eyes by reducing the brightness of a portion of a screen and not by reducing the brightness of the entire PDP. Human eyes are not so sensitive to brightness differences but are sensitive to color. Therefore, it is desirable to reduce brightness without changing color.

### SUMMARY OF THE INVENTION

The present invention provides a Plasma Display Panel (PDP) that can reduce power consumption by forming transparent electrodes so that the brightness of the PDP can be gradually reduced from a central region towards outer regions of the PDP.

According to one aspect of the present invention, a Plasma Display Panel (PDP) is provided including: a first substrate and a second substrate facing each other; a plurality of barrier ribs arranged between the first and second substrates to define a plurality of discharge cells; a plurality of sustain electrode pairs each having: a common electrode including a first bus electrode extending across the first substrate and a first transparent electrode bonded to the first bus electrode, each of the plurality of sustain electrode pairs is separated corresponding to each of the discharge cells, and has different areas in each discharge cell; and a scanning electrode including a second bus electrode extending across the first substrate and separated from the first bus electrode and a second transparent electrode bonded to the second bus electrode, the scanning electrode is separated corresponding to each of the discharge cells, and has different areas in each discharge cell; the areas of the first and second transparent electrodes are gradually reduced outwards from the center of the PDP; a first dielectric layer covering the sustain electrode pairs; a plurality of phosphor layers arranged within the discharge cells; and a discharge gas contained within each of the discharge cells.

The PDP preferably further includes: a plurality of address electrodes crossing the sustain electrode pairs and extending across the second substrate in the discharge cells; and a second dielectric layer covering the address electrodes.

According to another aspect of the present invention, a Plasma Display Panel (PDP) is provided including: a first substrate and a second substrate facing each other; a plurality of barrier ribs arranged between the first and second substrate to define a plurality of discharge cells; a plurality of sustain electrode pairs each having: a common electrode including a first bus electrode extending across the first substrate and a first transparent electrode extending along the first bus electrode and bonded to the first bus electrode, the common electrode including a plurality of openings separated from each other by different intervals between the openings; and a scanning electrode including a second bus electrode extending across the first substrate and separated from the first bus electrode and a second transparent electrode extending along the second bus electrode and bonded to the second bus electrode, the scanning electrode including a plurality of openings separated from each other by different intervals between the openings; sizes of the openings of the first and second transparent electrodes are different from each other and the intervals between the openings are gradually reduced outwards from the center of the first and second transparent electrodes; a first dielectric layer covering the sustain electrode pairs; a plurality of phosphor layers arranged within the discharge cells; and a discharge gas contained within each of the discharge cells.

The PDP preferably further includes: a plurality of address electrodes crossing the sustain electrode pairs and extending across the second substrate in the discharge cells; and a second dielectric layer covering the address electrodes.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial cutaway exploded perspective view of a PDP according to an embodiment of the present invention;

FIG. 2 is a plan view of a structure of a common electrode and a scanning electrode of the PDP according to an embodiment of the present invention of FIG. 1;

FIG. 3 is a partial cutaway exploded perspective view of a PDP according to another embodiment of the present invention;

FIG. 4 is a plan view of a structure of a common electrode and a scanning electrode of the PDP according to another embodiment of the present invention of FIG. 3;

FIG. 5 is a partial cutaway exploded perspective view of a PDP according to still another embodiment of the present invention; and

FIG. 6 is a plan view of a structure of a common electrode and a scanning electrode of the PDP according to still another embodiment of the present invention of FIG. 5.

### DETAILED DESCRIPTION OF THE INVENTION

The present invention is described more fully below with reference to the accompanying drawings in which exemplary embodiments of the present invention are shown.

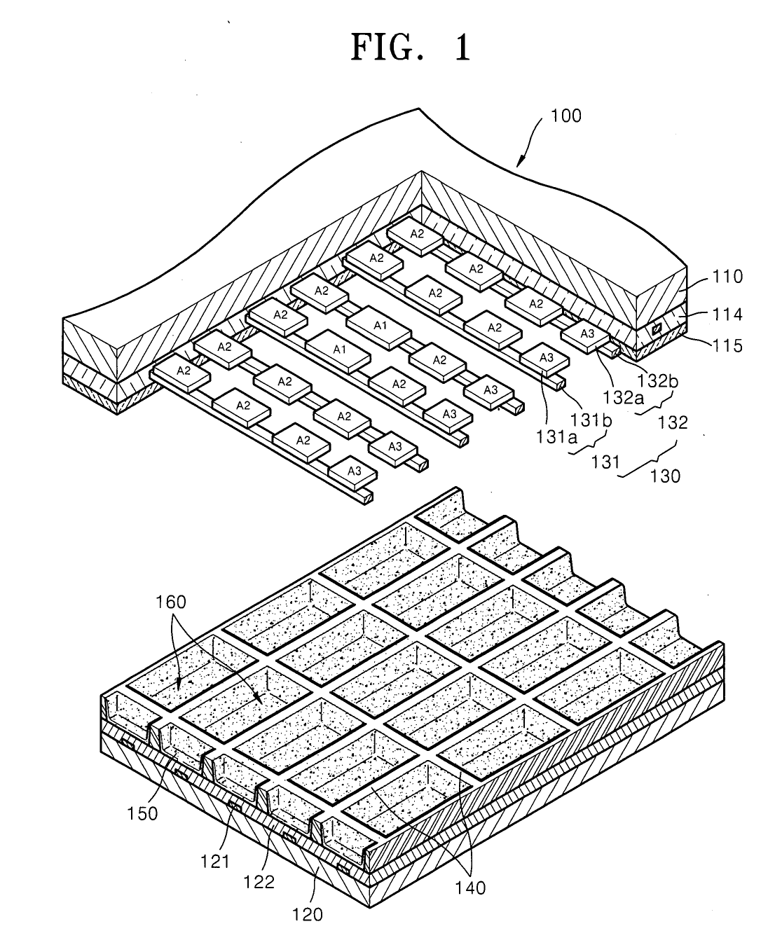

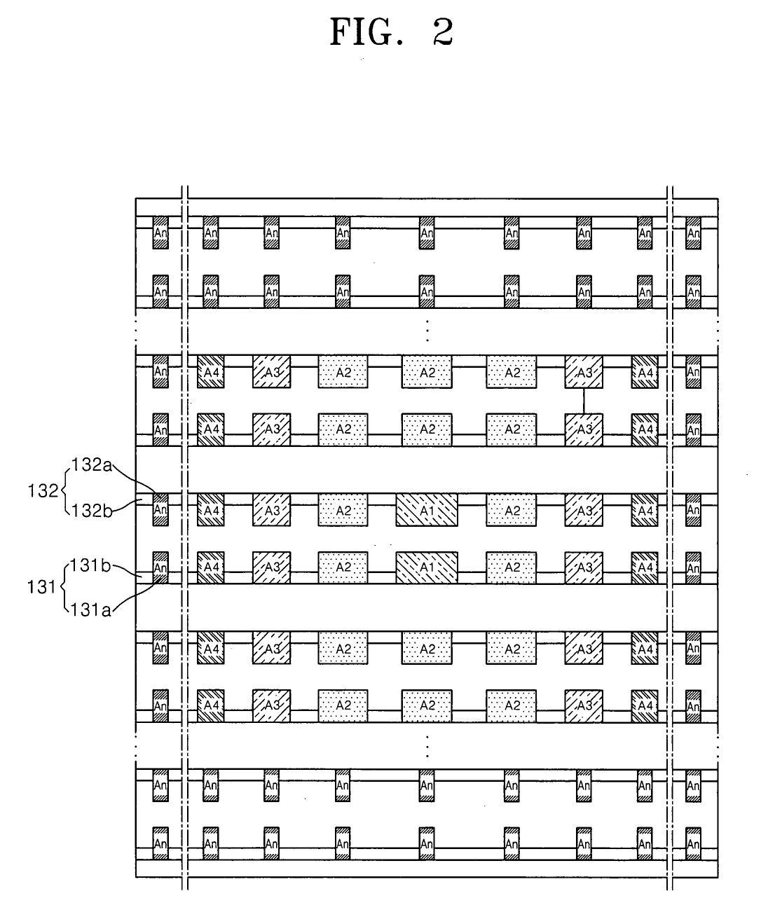

FIG. 1 is a partial cutaway exploded perspective view of a PDP 100 according to an embodiment of the present invention, and FIG. 2 is a plan view of a structure of a common electrode and a scanning electrode of the PDP 100 of FIG. 1.

Referring to FIGS. 1 and 2, the PDP 100 includes a first substrate 110 and a second substrate 120 disposed a predetermined distance apart from the first substrate 110 and parallel to the first substrate 110.

The first substrate 110 is transparent using glass as a main material so that visible light generated by discharges can pass through the first substrate 110. However, the present invention is not limited thereto. That is, the first substrate 110 can be non-transparent while the second substrate 120 can be transparent, or both the first and second substrate 110 and 120 can be transparent. Alternately, the first and second substrates 110 and 120 can be formed of a semi-transparent material, and a color filter (not shown) can be included on the surfaces or within the first and second substrates 110 and 120.

Sustain electrode pairs 130, each consisting of a pair of common electrodes 131 and a scanning electrode 132, are formed on the first substrate 110. The common electrodes 131 each include a transparent electrode 131a and a bus electrode 131b, and the scanning electrode 132 also includes a transparent electrode 132a and a bus electrode 132b.

In the present invention, the sustain electrode pairs 130 are disposed on the rear surface of the first substrate 110. The location of the sustain electrode pairs 130 according to the present invention is not limited to the rear surface of the first substrate 110; that is, the sustain electrode pairs 130 can be disposed a predetermined distance apart from the first substrate 110.

The transparent electrodes 131a and 132a, formed of Indium Tin Oxide (ITO), are respectively separated corresponding to discharge cells 160 and bonded to the bus electrodes 131b and 132b. The bus electrodes 131b and 132b are located on an upper part of the discharge cells 160.

FIG. 2 is a plan view of a structure of a common electrode and a scanning electrode of the PDP according to an embodiment of the present invention of FIG. 1. In FIG. 2, the areas of the transparent electrodes 131a and 132a are different from each other. That is, the areas of the transparent electrodes 131a and 132a in the PDP 100 are gradually reduced from a central region towards outer regions of the PDP 100.

For example, in the PDP 100, it is assumed that the central region of the PDP 100 is a first region; upper and lower, left and right regions separated a predetermined distance from the first region is a second region; upper and lower, left and right regions separated a predetermined distance from the second region is a third region; and upper and lower, left and right regions separated a predetermined distance from the third region is a fourth region. Also, assuming that the area of the transparent electrodes 131a and 132a in the first region is A1, the area of the transparent electrodes 131a and 132a in the second region is A2, the area of the transparent electrodes 131a and 132a in the third region is A3, and the area of the transparent electrodes 131a and 132a in the fourth region is A4, the areas of the transparent electrodes 131a and 132a are A1>A2>A3>A4.

As described above, since the areas of the transparent electrodes 131a and 132a are reduced from the central region to the outer regions of the PDP 100, the brightness of the PDP 100 is relatively reduced from the central region to the outer regions of the PDP 100, thereby reducing power consumption.

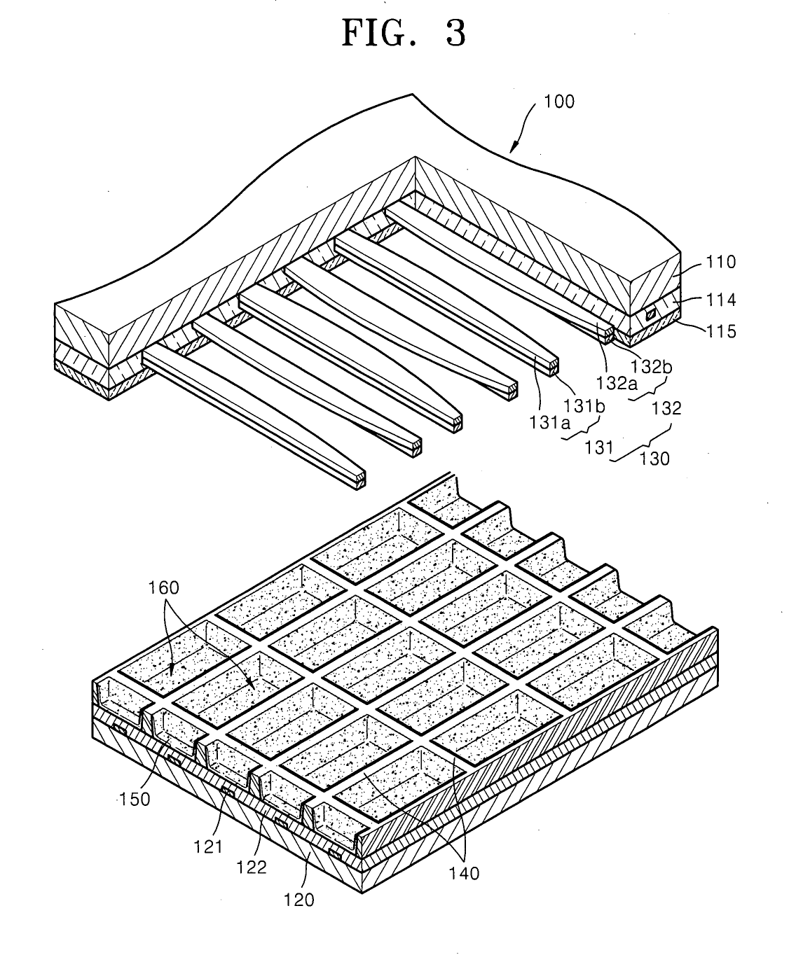

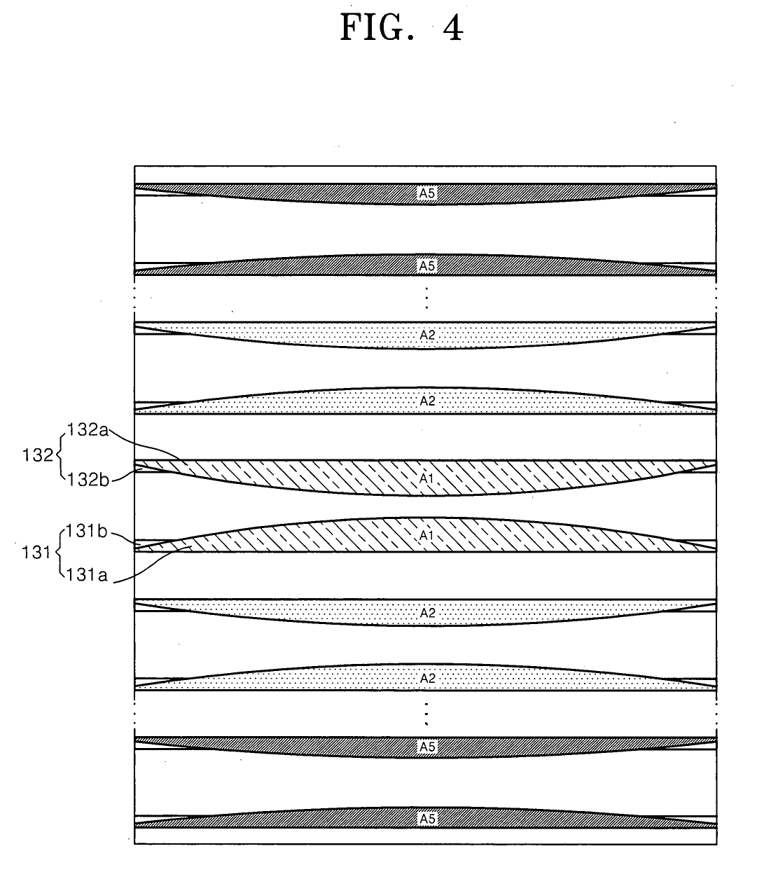

FIG. 3 is a partial cutaway exploded perspective view of a PDP according to another embodiment of the present invention, and FIG. 4 is a plan view of a structure of a common electrode and a scanning electrode of the PDP of FIG. 3. The electrode structure depicted in FIG. 4 includes transparent electrodes 131a and 132a having a shape different from the electrode structure of FIG. 2.

In the PDP 100 according to another embodiment, depicted in FIG. 3, transparent electrodes 131a and 132a are formed to consecutively cross discharge cells 160 in the same way as bus electrodes 131b and 132b. The bus electrodes 131b and 132b are disposed on an upper part of the discharge cells 160.

In the PDP 100 according to another embodiment, depicted in FIG. 4, the transparent electrodes 131a and 132a are formed to have different areas. That is, the areas of the transparent electrodes 131a and 132a in the PDP 100 are formed to reduce from an arbitrary point of the central region to outer regions of the transparent electrodes 131a and 132a. In FIG. 4, the shape of the transparent electrodes 131a and 132a is a half-moon shape in which the width is gradually reduced from the center towards the outer regions of the PDP 100. However, the present invention is not limited thereto.

The purpose of the structure described above is to gradually reduce brightness from the center towards the outer regions of the PDP 100 by gradually reducing the areas of the transparent electrodes 131a and 132a from the center towards the outer regions of the PDP 100, and thus to reduce power consumption.

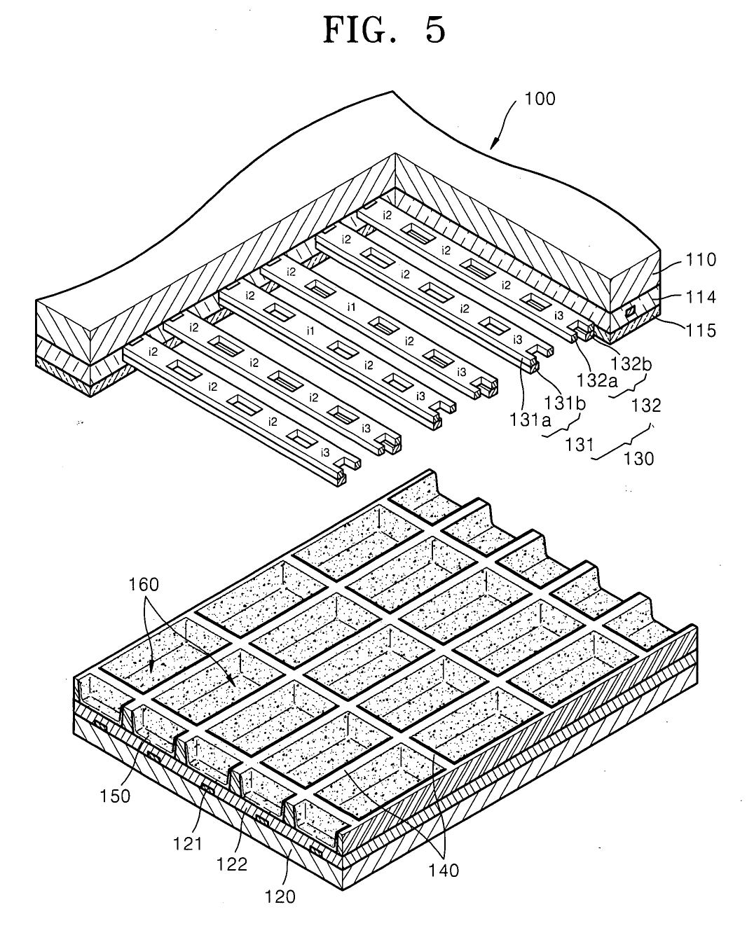

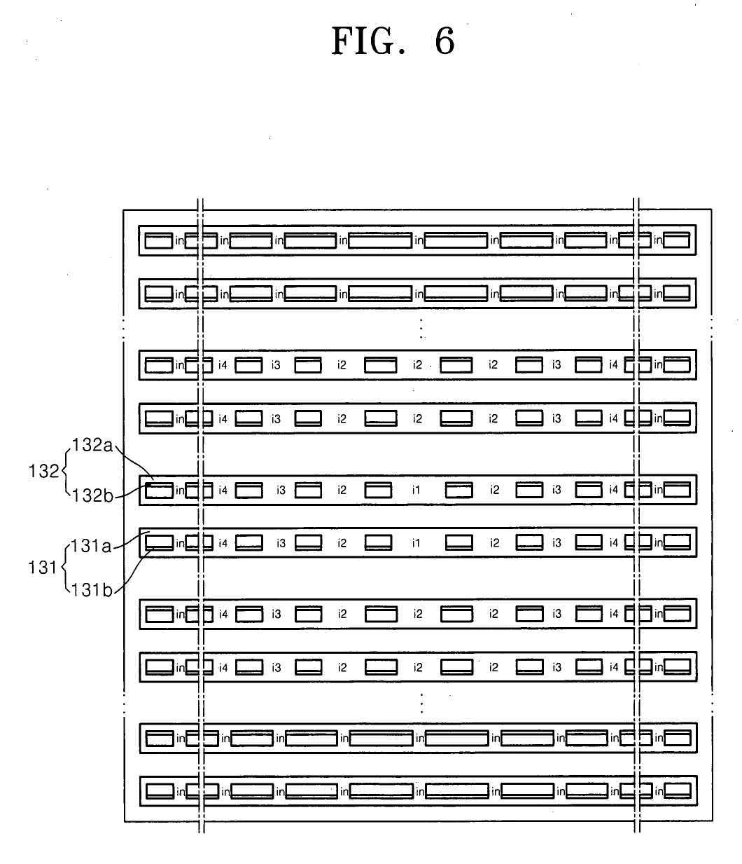

FIG. 5 is a partial cutaway exploded perspective view of a PDP 100 according to still another embodiment of the present invention, and FIG. 6 is a plan view of a structure of a common electrode and a scanning electrode of the PDP 100 of FIG. 5.

In the PDP 100 according to still another embodiment, depicted in FIG. 5, transparent electrodes 131a and 132a are formed to consecutively cross discharge cells 160 in the same way as bus electrodes 131b and 132b, and a plurality of openings 133 having different sizes are formed in the transparent electrodes 131a and 132a. The bus electrodes 131b and 132b are disposed on an upper part of the discharge cells 160.

In the PDP 100 according to another embodiment, depicted in FIG. 6, intervals between the openings 133 formed in the transparent electrodes 131a and 132a are different. That is, the intervals between the openings 133 formed in the transparent electrodes 131a and 132a are gradually reduced from an arbitrary point of the center towards the outer regions of the PDP 100.

For example, in the PDP 100, it is assumed that the central region of the PDP 100 is a first region, upper and lower, left and right regions separated a predetermined distance from the first region is a second region, upper and lower, left and right regions separated a predetermined distance from the second region is a third region, and upper and lower, left and right regions separated a predetermined distance from the third region is a fourth region. Also, assuming that the interval at the first region is I1, the interval at the second region is I2, the interval at the third region is I3, and the interval at the fourth region is I4, the intervals between the openings 133 are I1>I2>I3>I4.

The purpose of the structure described above is to have gradually reduced brightness from the center towards the outer regions of the PDP 100 by gradually reducing the areas of the transparent electrodes 131a and 132a from the center towards the outer regions of the PDP 100, and thus to reduce power consumption.

A first dielectric layer 114 covering the sustain electrode pairs 130 is formed on each of the rear surface of the first substrates 110 depicted in FIGS. 1, 3, and 4. The first dielectric layer 114 prevents the common electrode 131 and the scanning electrode 132 from directly electrically connecting to each other during a discharge, prevents the sustain electrode pairs 130 from being damaged by colliding with charged particles, and functions to accumulate wall charges by inducing the charged particles. The first dielectric layer 114 is formed of dielectric materials, such as PbO, B₂O₃, or SiO₂.

An MgO passivation layer 115 is formed below the first dielectric layer 114. The passivation layer 115 prevents the sustain electrode pairs 130 from being damaged by the sputtering of plasma particles and reduces the discharge voltage by emitting secondary electrons.

A plurality of address electrodes 121 are formed on a front surface of the second substrate 120. The address electrodes 121 perform an address discharge together with the scanning electrode 132.

A second dielectric layer 122 is formed on the address electrodes 121. The second dielectric layer 122 also protects the address electrodes 121 in the same way as the first dielectric layer 114.

In the present embodiment, the address electrodes 121 and the second dielectric layer 122 are included. However, the PDP 100 according to the present invention is not limited to such a structure. That is, the PDP can be operated without the address electrodes 121 and the second dielectric layer 122 through an appropriate design modification. That is, if there are no address electrodes 121, the common electrode 131 and the scanning electrode 132 are alternately disposed so that one of the common electrode 131 and the scanning electrode 132 can simultaneously perform an addressing function.

A plurality of barrier ribs 140 that maintain a discharge distance and prevent electrical and optical cross-talk between discharge cells 160 are formed on a front surface of the second dielectric layer 122.

The discharge cells 160 having an identical shape form a column in a direction where the sustain electrode pairs 130 are extending. A plurality of phosphor layers 150 are formed on an upper surface of the second dielectric layer 122 that constitutes lower surfaces of the discharge cells 160 and on both side surfaces of the barrier ribs 140 by coating phosphor materials of red, green, and blue color.

The phosphor layers 150 include a component that emits visible light by receiving ultraviolet rays. The red phosphor layers formed in the red light emitting discharge cell include a phosphor material, such as Y(V,P)O₄:Eu, the green phosphor layers formed in the green light emitting discharge cell include a phosphor material, such as Zn₂SiO₄:Mn, and the blue phosphor layers formed in the blue light emitting discharge cell include a phosphor material, such as BAM:Eu.

When the first substrate 110 and the second substrate 120 are combined, air is contained within the PDP 100. After the air contained within the PDP 100 has been completely exhausted, the PDP 100 is filled with an appropriate discharge gas that can increase discharge efficiency. The discharge gas can be a gas mixture, such as Ne—Xe gas, He—Xe gas, or He—Ne—Xe gas.

A PDP according to the present invention can reduce power consumption of the PDP through gradually reducing brightness from a central region towards outer regions of the PDP by forming transparent electrodes such that areas of the transparent electrodes are gradually reduced from the central region towards the outer regions of the PDP, or such that intervals between openings are gradually reduced from the central region towards the outer regions of the PDP.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A Plasma Display Panel (PDP) comprising:
a first substrate and a second substrate facing each other;
a plurality of barrier ribs arranged between the first and second substrates to define a plurality of discharge cells;
a plurality of sustain electrode pairs each having:
a common electrode including a first bus electrode extending across the first substrate and a first transparent electrode bonded to the first bus electrode, each of the plurality of sustain electrode pairs is separated corresponding to each of the discharge cells, and has different areas in each discharge cell; and
a scanning electrode including a second bus electrode extending across the first substrate and separated from the first bus electrode and a second transparent electrode bonded to the second bus electrode, the scanning electrode is separated corresponding to each of the discharge cells, and has different areas in each discharge cell;
wherein the areas of the first and second transparent electrodes are gradually reduced outwards from the center of the PDP;
a first dielectric layer covering the sustain electrode pairs;
a plurality of phosphor layers arranged within the discharge cells; and
a discharge gas contained within each of the discharge cells.

2. The PDP of claim 1, further comprising:
a plurality of address electrodes crossing the sustain electrode pairs and extending across the second substrate in the discharge cells; and
a second dielectric layer covering the address electrodes.

3. A Plasma Display Panel (PDP) comprising:
a first substrate and a second substrate facing each other;
a plurality of barrier ribs arranged between the first and second substrate to define a plurality of discharge cells;
a plurality of sustain electrode pairs each having:
a common electrode including a first bus electrode extending across the first substrate and a first transparent electrode extending along the first bus electrode and bonded to the first bus electrode, the common electrode including a plurality of openings separated from each other by different intervals between the openings; and
a scanning electrode including a second bus electrode extending across the first substrate and separated from the first bus electrode and a second transparent electrode extending along the second bus electrode and bonded to the second bus electrode, the scanning electrode including a plurality of openings separated from each other by different intervals between the openings;
wherein sizes of the openings of the first and second transparent electrodes are different from each other and the intervals between the openings are gradually reduced outwards from the center of the first and second transparent electrodes;
a first dielectric layer covering the sustain electrode pairs;
a plurality of phosphor layers arranged within the discharge cells; and
a discharge gas contained within each of the discharge cells.

4. The PDP of claim 3, further comprising:
a plurality of address electrodes crossing the sustain electrode pairs and extending across the second substrate in the discharge cells; and
a second dielectric layer covering the address electrodes.
